(19) United States
(12) Patent Application Publication
(10) Pub. No.: US 2009/0170381 A1
(43) Pub. Date: Jul. 2, 2009

(54) Electrical Connector Structure

(76) Inventors: Christopher Sommovigo, Atlanta, GA (US); Stuart L. Marcus, Lutz, FL (US)

Correspondence Address: LAWRENCE R. OREMLAND, P.C., 5055 E. BROADWAY BLVD., SUITE C-214, TUCSON, AZ, 85711, US

(21) Appl. No.: 12/325,111

(22) Filed: Nov. 28, 2008

Related U.S. Application Data
(63) Continuation-in-part of application No. 11/749,085, filed on May 15, 2007, now abandoned.
(60) Provisional application No. 60/800,710, filed on May 16, 2006.

(51) Int. Cl. H01R 13/02

(52) U.S. Cl. 439/884

(57) ABSTRACT

A new and useful electrical connector structure is provided. The connector structure is particularly useful in connection with a pin: socket type electrical connector structure. The connector structure is designed to make the connector members efficient to manufacture and capable of providing good electrical contact but which does not require the type of close tolerances of previous known connector structures. The principles of the present invention are particularly useful in forming a high pressure pin: socket type electrical connector structure. According to the present invention, an electrical connector structure comprises (a) a pair of connector members that are configured to be coupled together to produce an electrical connection; with (b) one connector member having at least one contact ridge configured to make electrical contact with a substantially smooth contact surface portion of the other connector when the pair of connector members are coupled together. The connector structure enables high pressure contact between the connector members, essentially changes the low-pressure nature of a contact interface to a high pressure one, thus lowering the contact resistance of the interface. It accomplishes this by applying the same amount of contact force to a smaller area of contact, thus increasing psi at the point of contact. Moreover, the connector structure of the invention increases the contact pressure between mating surfaces, decreasing contact resistance and creating more of a gas-tight contact-area which will help to inhibit the formation of oxides and other “tarnishing” films that may degrade interface performance over time.

### RELATED APPLICATION/CLAIM OF PRIORITY

This application is a continuation in part of, and claims priority from, application Ser. No. 11/749,085, filed May 15, 2007, which application is related to and claims priority from provisional application Ser. No. 60/800,710, filed May 16, 2006. Application Ser. No. 11/749,085 and provisional application Ser. No. 60/800,710 are each incorporated by reference herein.

### BACKGROUND AND SUMMARY

Application Ser. No. 11/745,085 describes anew and useful electrical connector structure that is particularly useful in forming a high pressure electrical connector. The present application further describes structure and principles of the electrical connector structure that make it particularly useful with pin: socket type electrical connector members, and also with other types of electrical connector members.

As explained in application Ser. No. 11/745,085, known electrical connector structure comprises connector members that require careful manufacture, to achieve good electrical contact, because the connector members are configured to make contact over their entire contact profiles. Moreover, if wear of the contact surfaces, due e.g. to repeated use, causes a change in the profile of either connector member, the contact capabilities of the structure can be adversely affected. Thus, in manufacturing male and female connector members, the female pin type receptacle generally is produced with a larger inside diameter than the outside diameter of the male mating pin. The slots cut into the female receptacle provide flexibility, and the female receptacle opening is reduced or squeezed down first. This means that the female receptacle opening will be slightly smaller than the outer diameter (OD) of the male pin, and the slots will allow that opening to expand as the male pin is inserted. It also means that main contact is essentially made only at this point in the interface, as the remainder of the inner diameter (ID) of the female receptacle is larger than the OD of the mating male pin. Thus, if excessive wear of the contact surfaces, due e.g. to repeated use, causes a change in the profile of either connector member, the contact capabilities of the connector structure can be adversely affected.

The present invention provides a new and useful electrical connector structure. The principles of the present invention are particularly useful in connection with a pin: socket type electrical connector structure, and a method of forming the connector structure, that is designed to make the connector members efficient to manufacture and capable of increasing the contact pressure between mating surfaces, decreasing contact resistance and creating more of a gas-tight contact-area which will help to inhibit the formation of oxides and other “tarnishing” films that may degrade interface performance over time. The principles of the present invention are particularly useful in forming a high pressure electrical connector structure, e.g. of the type that is useful in critical digital and analog communications interfaces, audio and video interfaces, microwave transmission and critical military and aerospace interfaces.

In addition, the principles of the present invention can be used in forming other types of electrical connector structures (e.g. AC plug type connector members), where increased contact pressure between electrical members can improve the connection.

According to a preferred form of the present invention, an electrical connector structure comprises (a) a pair of connector members that are configured to be coupled together to produce an electrical connection; with (b) one connector member having at least one contact ridge configured to make electrical contact with a substantially smooth contact surface portion of the other connector when the pair of connector members are coupled together. Such structure enables high pressure contact between the connector members, but doesn't require the type of close tolerances required of prior connector members, because the contact ridges can make good electrical contact with the smooth contact surface over a range of contact profiles.

Thus, in a pin: socket type of connector, the invention essentially changes the low-pressure nature of any pin: socket interface to a high pressure one, thus lowering the contact resistance of the interface. It accomplishes this by applying the same amount of contact force to a smaller area of contact, thus increasing psi at the point of contact. Moreover, the connector structure of the invention increases the contact pressure between mating surfaces, decreasing contact resistance and creating more of a gas-tight contact-area which will help to inhibit the formation of oxides and other “tarnishing” films that may degrade interface performance over time.

According to a preferred embodiment, a male connector member has an outer contact surface that is formed with a plurality of contact ridges, and a female connector member has an inner contact surface that is formed as a substantially smooth surface. The female connector member has a slot that provides the female connector member with some ability to flexibly adjust as the connector members are coupled together. Additionally, the configurations of the connector members are designed to achieve particularly good electrical contact.

In this application, reference to a contact surface being “substantially smooth” means that the contact surface portion is prepared in a manner designed to avoid the formation of ridges.

Additionally, reference to the concept of one connector member configured to “flexibly adjust” to pressure between the connector members (e.g. as provided by the slits in a female connector) means that as the connector members are coupled together one member (e.g. the female connector) can flex slightly when the connector members are coupled, so that the contact ridges of the one connector press tightly against the substantially smooth contact surface portion of the other connector, to make good electrical contact, and to resist (or slow down) the formation of films between the contact surfaces of the connector members. Also, the “contact perimeter” of the contact ridges (e.g. of a male connector member) is a cylinder that is “tangent” to the innermost (in the case of a female connector) or outmost (in the case of a male connector) surface portions of the contact ridges.

Further features of the present invention will be apparent from the following detailed description and the accompanying drawings

### BRIEF DESCRIPTION OF THE DRAWINGS

FIG. 1 is an exploded view of a pair of electrical connector members, constructed according to the principles of the present invention, in a disconnected condition, and schematically showing the direction of movement of a male connector as it is being inserted into a female connector;

FIG. 2 is a cross sectional view of the electrical connector members of FIG. 1, in a connected condition;

FIG. 3 is an enlarged view of the area 3-3 of FIG. 2;

FIGS. 4a-4f schematically illustrate other examples of pin: socket electrical connector profiles that illustrate how the principles of the invention can be applied to various pin: socket electrical connector structures;

FIGS. 5a-5c schematically illustrate how the principles of the present invention can be applied to a grounded AC plug type electrical connector; and

FIGS. 6 and 7 schematically illustrate the principles by which good high pressure electrical contact is made between male and female connector members, according to the principles of the present invention.

### DETAILED DESCRIPTION

As described above, the present invention relates to electrical connector structure that is particularly useful in connection with a high pressure contact such as a pin: socket type of electrical connector structure. The principles of the invention are described below in connection with exemplary forms of electrical connector structure, and from that description it will be clear to those in the art the manner in which those principles can be used to form various forms of electrical connector structure.

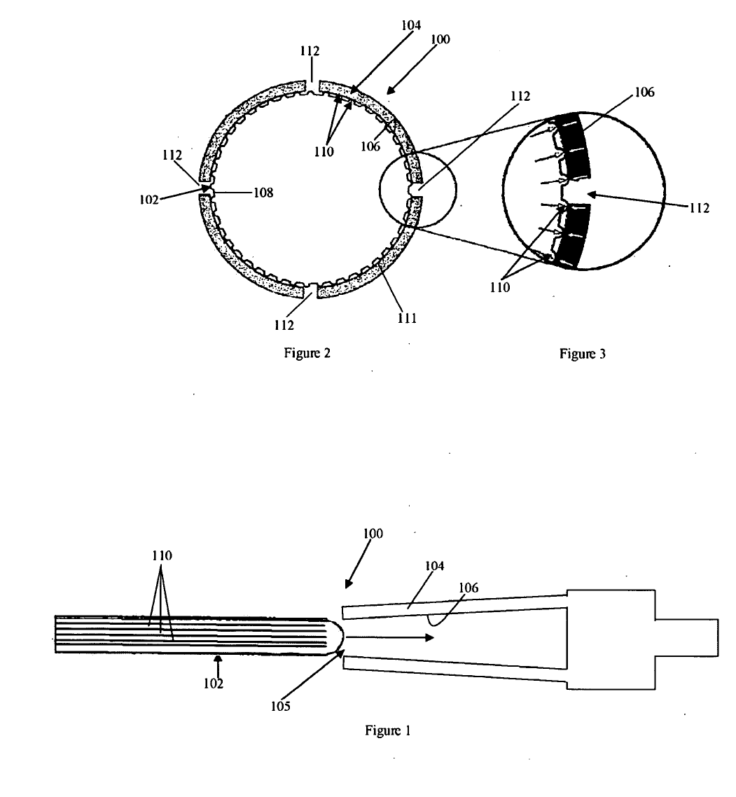

As shown in FIGS. 1-4, a pin: socket electrical connector structure 100 includes a male connector member 102 that mates with a female connector member 104. The female connector member 104 has a substantially smooth inner contact surface 106 (on its inside) that is preferably circular at an opening 105 of the female contact member, and the female contact member widens gradually as it extends away from the opening 105 (in the direction of the arrow in FIG. 1 that shows the direction in which the male connector member 102 is inserted into the female connector member 104). The male connector member 102 has an outer contact surface 108 with a plurality of contact ridges 110 that are configured according to the principles of the present invention.

The connector members 102, 104 are formed of good conducting materials (e.g. copper, brass, bronze, silver, aluminum, any electrically conductive pure metal or alloy), and have insulating (non conducting) supports that enable the connector members to be conveniently handled when they are being coupled or separated. The connector members are configured to be coupled together to produce an electrical connection, particularly a good high pressure electrical connection. In the example of FIGS. 1-3, the male connector 104 member has the contact ridges 110 that are configured to make good high pressure electrical contact with the substantially smooth inner contact surface portion 106 of the female connector member 104, at the opening 105 of the female connector member, when the pair of connector members are coupled together.

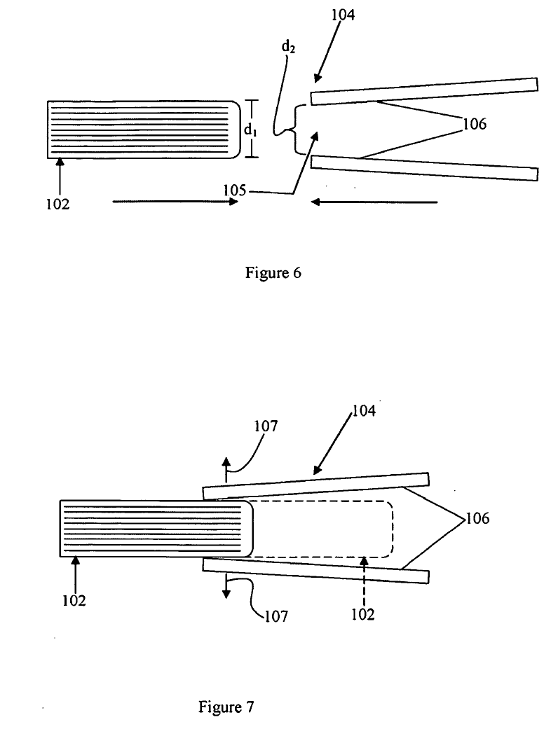

The contact surface 106 of the female connector, particularly at the opening 105, is preferably circular but could have other profiles (e.g. elliptical) so long as the contact surface at the opening 105 is substantially smooth. The male connector 102 has a substantially cylindrical contact ridge perimeter 111 that has a diameter that is substantially constant and slightly greater than the diameter of the substantially smooth cylindrical inner contact surface portion 106 of the female connector at the opening 105. Specifically, as shown in FIG. 6, the substantially cylindrical contact ridge perimeter of the male connector 102 is shown at d₁ and the diameter of the substantially smooth contact surface of the female connector 104 at the opening 105 is shown at d₂. The diameter d₂ of the substantially smooth contact surface of the female connector 104 at the opening 105 is thus slightly smaller than the diameter d₁ of the contact ridge perimeter of the male connector. Moreover, as seen from FIGS. 1, 6 and 7, the female connector widens radially as it extends axially away from the opening 105 (in FIG. 1 the single arrow, and in FIG. 6, the pair of arrows show the axial direction of the male and female members as they are moved toward each other to establish electrical connection).

The female connector 104 has at least one slot 112 that extends at least partially along the length (i.e. the axial length, represented by the arrows in FIGS. 1 and 6) of the female connector, and enables the female connector to flexibly adjust to pressure between the connector members as the connector members are coupled together.

The male connector member 102 preferably has a substantially constant diameter cylindrical contact ridge perimeter 111 and the female connector member 104 preferably has a substantially smooth circular contact surface 106 at the mouth 105 with a diameter that is smaller than the diameter of the contact ridge perimeter 111 of the male connector member. The connector members may have profiles other than cylindrical and circular, in which case the contact ridge perimeter and substantially smooth contact surface portions are generally similar in configuration. What is important is that the connector members are configured such that electrical contact is established and maintained substantially between the contact ridges on the male connector and the substantially smooth contact surface of the female connector at the opening 105 in the female connector, and as the male connector member extends further into the female connector, the widening portions of the female connector are spaced from the male connector at all places except for the contact at the substantially smooth contact surface of the female connector at the contact opening 105. FIG. 7 shows in dashed lines the manner in which the male connector is spaced from the inner surface of the female connector at all places except for the contact between the contact ridges of the male connector with the substantially smooth contact surface of the female connector at the contact opening 105.

The male connector member 102 can be formed in various ways. Specifically the male connector member 102 can be cast or molded with the contact ridges 10. The male connector member can also be formed with a cylindrical initial configuration, and the plurality of contact ridges can be formed by techniques such as fluting, knurling, etching, milling, forging, or any technique that allows for the contact ridges to be formed from the material of the pin member itself

Also, while the foregoing preferred embodiment relates to a male connector member with contact ridges on its outer perimeter, it is contemplated that the female connector member could be formed with the contact ridges on its inner perimeter, in which case the male connector member would have a substantially smooth, and preferably circular outer perimeter. The contact ridges on the female connector member would be formed, e.g. by fluting, knurling, etching, milling, drilling, forging, or any technique that allows for the formation of contact ridges from the material of the female receptacle itself.

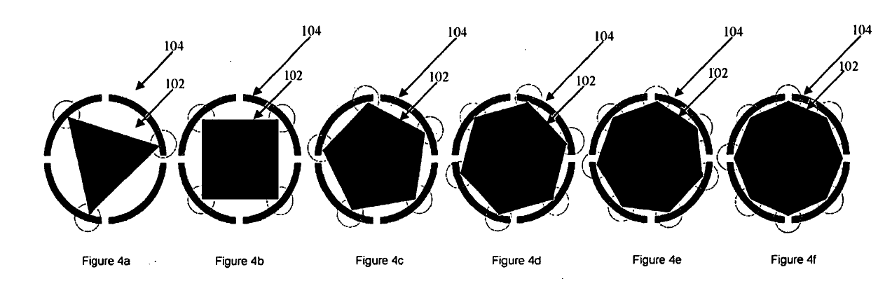

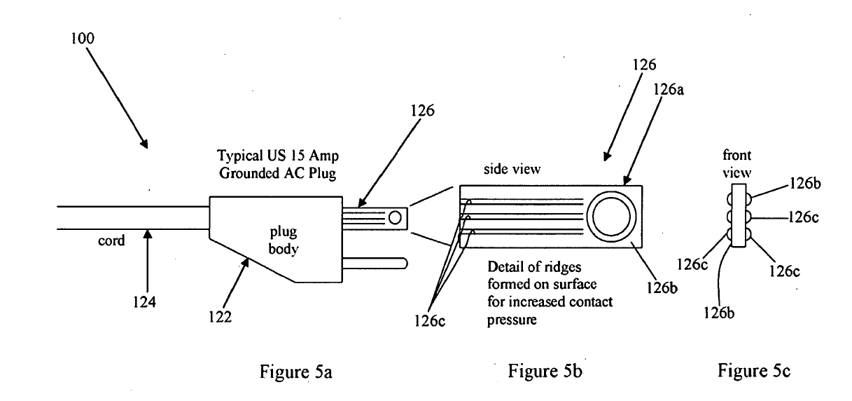

In addition, it is also contemplated that the outer perimeter of the contact ridges could have various forms. For example, as illustrated in FIGS. 4a-4f, if the contact ridges are on the male connector member 102, the contact ridges could be, e.g., in a triangular profile, a square profile, a hexagon, or various other configurations that will be apparent to those in the art. The contact profiles of FIGS. 4a-4f have the same effect of creating high-pressure contact points along the lengths of the male connector member, because the comers of the polygonal male connector members provide contact ridges that produce points of contact with the mating interior surface of the female connector member.

As will be apparent to those in the art, the invention essentially changes the low-pressure nature of any pin: socket interface to a high pressure one, thus lowering the contact resistance of the interface. It accomplishes this by applying the same amount of contact force to a smaller area of contact, thus increasing psi at the point of contact. Moreover, the connector structure of the invention increases the contact pressure between mating surfaces, decreasing contact resistance and creating more of a gas-tight contact-area which will help to inhibit the formation of oxides and other “tarnishing” films that may degrade interface performance over time.

Still further, while the preferred embodiment relates to connector members which have contact ridges and/or smooth contact surfaces that are substantially continuous, it is contemplated that both the contact portions of the connector members could be other than continuous. For example, the substantially smooth contact surface (e.g. on the female connector) could be arcuate but not a continuous circle and the contact ridges could be on a mating male connector with a contact ridge profile that substantially matches the profile of the substantially smooth contact surface of the female connector.

In addition, while the foregoing description explains how the principles of the present invention are applied to a pin: socket type of electrical connector structure, the principles of the present invention can be applied to other types of electrical connector structures, particularly where a high contact pressure is desirable. For example, FIGS. 5a-5c schematically illustrate how the principles of the present invention can be applied to an a typical US 15 Amp grounded alternating current (AC) plug 120. The plug 120 comprises a plug body 122 connected with a cord 124, a pair of contact members 126 (one is shown) and a ground connector 128 extending from the plug body 122. The details of the plug body 122, the cord 124 and the ground connector 128 are conventional and should not require further description to those in the art.

In the embodiment of FIGS. 5a-5c, the contact members 126 are formed according to the principles of the present invention. Each contact member 126 member comprises a rectangular body 126a, with a pair of opposite surfaces 126b, and a plurality of contact ridges 126c on each surface 126b. The contact members 126 are designed to fit into mating slots (not shown) in a female connector. Those slots are also conventional, and include connector surface(s) that are smooth, and should not require further description to those in the art.

The connector members 126 can be formed in various ways. Specifically the connector members 126 comprise of electrically conductive material and be cast or molded with the contact ridges 126c. The connector members 126 can also be formed with a rectangular initial configuration, and the plurality of contact ridges 126c can be formed by techniques such as fluting, knurling, etching, milling, forging, or any technique that allows for the contact ridges to be formed from the material of the contact member itself.

Also, as will be apparent to those in the art, the contacts 126 are supported from the plug body 122 in cantilevered fashion, and because of that support, and the manner in which the mating connector members are supported in the female connector members, one or both of the contact members 126 or the mating connector members of the female connector members have some flexibility that enables the connector members to flexibly adjust to pressure between the connector members as the connector members are coupled together.

Thus, with the foregoing AC plug structure, and as will be apparent to those in the art, the invention essentially provides increased contact pressure at the connector interface, thus lowering the contact resistance of the interface, by applying the same amount of contact force to a smaller area of contact, thus increasing psi at the point of contact. Moreover, as with the pin: socket connection, the AC plug connector structure increases the contact pressure between mating surfaces, decreasing contact resistance and creating more of a gas-tight contact-area which will help to inhibit the formation of oxides and other “tarnishing” films that may degrade interface performance over time.

Thus, the foregoing description and drawings show and describe an electrical connector structure that comprises (a) a pair of connector members that are configured to be coupled together, to produce an electrical connection; (b) the pair of connector members configured such that a portion of one connector member is located inside a portion of the other connector member when the pair of connector members are coupled together, where (c) one connector member has one or more contact ridges configured to make electrical contact with a substantially smooth contact surface portion at an opening of the other connector member when the pair of connector members are coupled together, the pair of connector members further configured such that contact between the pair of connector members occurs substantially at the opening, and the remaining portions of the connector members are substantially spaced from each other, so that contact between the pair of connector members is provided substantially at the opening between the contact ridges and the substantially smooth contact surface, and the remaining portions of the connector members are substantially spaced from each other.

Moreover, the description and drawings show and describe the one connector member is preferably a male connector and the other connector member is preferably a female connector. The male connector has an outer surface with the plurality of contact ridges and a substantially constant contact ridge perimeter diameter. The female connector has a substantially smooth inner contact surface portion at a contact opening in the female connector, and the inner portion of the female connector widens away from the opening, in the direction in which the male connector is inserted into the female connector. Thus, when the male connector is inserted through the contact opening in the female connector, good high pressure electrical contact is made between the contact ridges of the male connector and the contact opening in the female connector, and the portion of the male connector that is disposed inside the widening inner portion of the female connector is spaced from the widening inner portion of the female connector.

Additionally, the contact opening of the female connector is biased to a configuration such that the contact opening has a diameter that is smaller than the contact ridge perimeter diameter of the male contact member, and wherein the female connector has at least one slot that enables the female connector to flexibly adjust to high pressure contact between the connector members as the male connector is inserted into the female connector and the connector members are coupled together, to facilitate insertion of the male member into and through the contact opening and to establish and maintain good high pressure electrical contact between the contact ridge perimeter and the contact opening when the connector members are coupled together.

With the foregoing disclosure in mind, the manner in which the principles of the present invention can be used to produce various types of electrical connector structures will be apparent to those in the art.

1. Electrical connector structure comprising
(a) a pair of connector members that are configured to be coupled together, to produce an electrical connection;
(b) the pair of connector members configured such that a portion of one connector member is located inside a portion of the other connector member when the pair of connector members are coupled together,
(c) one connector member having one or more contact ridges configured to make electrical contact with a substantially smooth contact surface portion at an opening of the other connector when the pair of connector members are coupled together, the pair of connector members further configured such that contact between the pair of connector members occurs substantially at the opening, and the remaining portions of the connector members are substantially spaced from each other, so that contact between the pair of connector members is provided substantially at the opening between the contact ridges and the substantially smooth surface, and the remaining portions of the connector members are substantially spaced from each other

2. Electrical connector structure as defined in claim 1, wherein the one connector member is a male connector and the other connector member is a female connector: the male connector having an outer surface with the plurality of contact ridges and a substantially constant contact ridge perimeter diameter, the female connector having a substantially smooth inner contact surface portion at a contact opening in the female connector, and the inner portion of the female connector widening away from the opening, in the direction in which the male connector is inserted into the female connector, so that when the male connector is inserted through the contact opening in the female connector, electrical contact is made between the contact ridges of the male connector and the contact opening in the female connector, and the portion of the male connector that is disposed inside the widening inner portion of the female connector is spaced from the widening inner portion of the female connector.

3. Electrical connector structure as defined in claim 2, wherein the contact opening of the female connector is biased to a configuration such that the contact opening has a diameter that is smaller than the contact ridge perimeter diameter of the male contact member, and wherein the female connector has at least one slot that enables the female connector to flexibly adjust to pressure between the connector members as the male connector is inserted into the female connector and the connector members are coupled together, to facilitate insertion of the male member into and through the contact opening and to establish and maintain good electrical contact between the contact ridge perimeter and the contact opening when the connector members are coupled together.

4. Electrical connector structure as defined in claim 1, wherein at least one of the connector members has a configuration that enables such connector member to flexibly adjust to pressure between the connector members the connector members are coupled together, to facilitate and maintain good electrical contact between the contact ridges of one connector member and the substantially smooth contact opening of the other connector member as the connector members are coupled together.

5. Electrical connector structure as defined in claim 4, wherein the one connector member has a substantially constant diameter cylindrical contact ridge perimeter and the other connector member has a contact opening with a substantially smooth circular contact surface that is biased to a configuration such that the diameter of the contact opening is smaller than the substantially constant diameter cylindrical contact ridge perimeter.
